(19) United States
(12) Patent Application Publication
(10) Pub. No.: US 2016/0226118 A1
(43) Pub. Date: Aug. 4, 2016

(54) SODIUM-BASED HYBRID FLOW BATTERIES WITH ULTRAHIGH ENERGY DENSITIES

(71) Applicants: Leon L. SHAW, Chicago, IL (US); Jack S. SHAMIE, Chicago, IL (US)

(72) Inventors: Leon L. SHAW, Chicago, IL (US); Jack S. SHAMIE, Chicago, IL (US)

(21) Appl. No.: 14/157,180

(22) Filed: Jan. 16, 2014

Related U.S. Application Data
(60) Provisional application No. 61/753,479, filed on Jan. 17, 2013.
(60) Provisional application No. 61/885,305, filed on Oct. 1, 2013.

(51) Int. Cl. H01M 12/08; H01M 10/054; H01M 10/0566; H01M 8/1016; H01M 10/0562; H01M 10/0563; H01M 8/18; H01M 4/38

(52) U.S. Cl. CPC H01M 12/08; H01M 8/188; H01M 10/054; H01M 4/381; H01M 8/1016; H01M 10/0562; H01M 10/0563; H01M 10/0566; H01M 2004/027

(57) ABSTRACT

A sodium-based hybrid flow battery characterized by ultrahigh energy density includes a flow cathode, a non-flow sodium-based anode spaced apart from the flow cathode and with a solid non-porous ion exchange membrane disposed between the flow cathode and the anode. The flow cathode is in fluid flow communication with a source of a catholyte material. In operation, flow of the catholyte material in the flow cathode and diffusion of sodium ions through the non-porous ion exchange membrane produce electrical energy. Also provided are corresponding or associated methods of producing electrical energy.

### FIELD OF THE INVENTION

This invention relates generally to redox flow batteries and, more specifically, to high voltage sodium-based hybrid flow batteries with ultrahigh energy densities.

### BACKGROUND OF THE INVENTION

The concept of redox flow batteries (RFBs) has been around since at least the early 1970s when. NASA investigated iron and chromium redox couples for space applications. A critical issue with such redox systems was the permeation of iron species into the chromium electrolyte and vice versa, causing rapid performance degradation.

In the mid-1980s, all vanadium redox batteries (VRBs) were proposed. FIG. 1 is a schematic showing the key components of typical RFBs which store energy in two soluble redox fluids contained in external electrolyte storage tanks. The redox fluids are pumped from the storage tanks to flow through the electrode chambers where chemical energy is converted to electrical energy (discharge) or vice versa (charge).

More particularly, FIG. 1 shows an all vanadium redox flow battery, the redox flow battery generally being designated with the reference numeral 10. All existing RFBs typically have the same general design shown here. The battery 10 includes two compartments (positive and negative electrodes, 12 and 14, respectively) separated by an ion exchange membrane 16. Each of the compartments 12 and 14 is connected to a respective reservoir tank 22 and 24 and a respective pump 26 and 28 through a respective electrolyte circuit loop 32 and 34, to appropriately circulate a respective selected electrolyte material 42 and 44.

Subsequently, other redox battery chemistries such as vanadium-bromine, polysulphide-bromide, zinc-bromide, zinc-cerium redox batteries were investigated. Unlike Li-ion batteries where electrodes intercalate/deintercalate Li ions to enable electron transfer processes, the electrodes of RFBs are “inert” with no intercalation/deintercalation and stress buildup. As a result, RFB electrodes have the potential for very long cycle life. To provide normally acceptable power ratings (kW), the electrode size of Li-ion batteries has to be limited, and thus so is the energy storage capacity (kWh) of Li-ion batteries. In contrast, the power of RFBs is determined by the size of the electrodes and the number of cells in a stack, whereas the energy storage capacity of RFBs is customarily dictated by the concentration and volume of the electrolyte. Therefore, the power and storage capacity of RFBs can be designed independently. As a result, both energy and power can be easily adjusted for storage from a few hours to days or weeks, depending on the application. Another important advantage of RFBs over Li-ion batteries is the ease of heat management because flowing electrolytes carry away heat generated from ohmic heating and redox reactions, leading to a super safe energy storage system.

There are many patents in the area of redox flow batteries, including for example: U.S. Pat. No. 7,704,634 B2. Method For Designing Redox Flow Battery System: EP 1 143 546 A1, Redox Flow Battery; U.S. Pat. No. 8,288,030 B2, Redox Flow Battery; and U.S. Pat. No. 6,475,661 B1. Redox Flow Battery System and Cell Stack. However, none of these prior patents are similar to the invention described herein as, for example, these prior patent RFBs use aqueous solutions in both the anode and cathode to accomplish electrochemical reactions.

In spite of the many advantages mentioned above, current state-of-the-art RFBs commonly suffer from certain critical drawbacks or shortcomings, including, for example, low energy density 20˜33 Wh/liter and low specific energy 15˜25 Wh/kg. Further, current state-of-the-art RFBs typically use an aqueous media for both anode and cathode reactions. This limits the operating voltage of a cell to around 1.3 volts.

### SUMMARY OF THE INVENTION

This invention provides high voltage sodium-based hybrid flow batteries with ultrahigh energy densities which overcome or effectively alleviate one or more of the shortcomings described above.

The present invention, in one aspect, provides a novel sodium-based hybrid flow battery. As described in greater detail below, such a battery can desirably include a flow cathode, a non-flow sodium-based anode spaced apart from the flow cathode, and a solid non-porous ion exchange membrane disposed between the flow cathode and the non-flow anode. The flow cathode is in fluid flow communication with a source of a catholyte material. More particularly, flow of the catholyte material in the flow cathode and diffusion of sodium ions through the non-porous ion exchange membrane serve to produce electrical energy.

In another embodiment, the invention provides a high voltage sodium-based hybrid flow battery with ultrahigh energy density. Such a battery includes a flow cathode. The flow cathode is in fluid flow communication with a source of a catholyte material. The battery also includes a stationary sodium-based anode spaced apart from the flow cathode. The stationary sodium-based anode contains molten sodium or a molten sodium-containing alloy. The battery further includes a solid non-porous ion exchange membrane disposed in a horizontal orientation between the flow cathode and the anode. The solid non-porous ion exchange membrane desirably is constructed of β″-Al₂O₃, a NaSICON solid, or a combination thereof. In the battery, flow of the catholyte material in the flow cathode and diffusion of sodium ions through the solid non-porous ion exchange membrane act or serve to produce electrical energy.

Another aspect of the invention relates to methods for producing electrical energy. In one particular embodiment, one such method involves producing electrical energy via a sodium-based hybrid flow battery. The sodium-based hybrid flow battery contains a flow cathode and a non-flow sodium-based anode with a solid non-porous ion exchange membrane disposed therebetween. A catholyte material is flowed in the flow cathode in communication with the non-flow sodium-containing anode through the solid non-porous ion exchange membrane. For discharge of the battery, sodium ions diffuse from the non-flow sodium-based anode to the flow cathode through the solid non-porous ion exchange membrane. For charge of the battery, sodium ions diffuse from the flow cathode to the non-flow sodium-based anode through the solid non-porous ion exchange membrane.

As used herein, references to “hybrid flow batteries” are to be understood to refer to batteries that include one of an anode or cathode that utilizes a flowing electrolyte and the other of the anode or cathode is non-flow, such as in the form of a stationary or floating electrode, for example. In certain particular embodiments more particularly described below, the invention provides sodium-based hybrid flow batteries that have a flow cathode and a non-flow sodium-based anode.

Further, references herein to “high voltage” when referring to high voltage sodium-based hybrid flow batteries such as herein described and provided are to be understood to refer to such batteries as providing or supplying 2 V or more.

References herein to “ultrahigh energy densities” when referring to high voltage sodium-based hybrid flow batteries such as herein described and provided are to be understood to refer to such batteries as energy densities that are gravimetrically greater than 200 Wh/kg and volumetrically greater than 300 Wh/L.

Other objects and advantages will be apparent to those skilled in the art from the following detailed description taken in conjunction with the appended claims and drawings.

### BRIEF DESCRIPTION OF THE DRAWINGS

Objects and features of this invention will be better understood from the following description taken in conjunction with the drawings, wherein:

FIG. 1 is a schematic illustration of a conventional vanadium redox flow battery.

FIG. 2 is a schematic illustration of a sodium-based hybrid flow battery with ultrahigh energy densities in accordance with one embodiment of the invention.

FIG. 3 is a Na—K phase diagram, showing that Na—K alloy can be in a molten state at temperatures as low as -12.6° C.

FIG. 4 is a Na—Cs phase diagram, showing that the Na—Cs alloy can be in a molten state at temperatures as low as −31.8° C.

FIG. 5 is a Na—Sr phase diagram, showing that Na is soluble in Sr.

FIG. 6 is a schematic illustration of a Sr-coated β″-Al₂O₃/NaSICON bi-layer membrane in accordance with one embodiment of the invention.

FIG. 7 is a graphical representation of range (e.g., specific energy) versus acceleration (e.g., specific power) for various electrochemical energy storage devices available today.

FIG. 8 is a graphical representation of Open Circuit Voltage (OCV) versus time obtained in the course of Example 1.

FIG. 9 is a graphical representation of current versus over-potential obtained in the course of Example 2.

FIG. 10 is a graphical representation of cell voltage versus time obtained in the course of Example 3.

FIG. 11 is a graphical representation of cell voltage versus time obtained in the course of Example 4.

FIG. 12 is a close-up of the first two cycles shown in FIG. 11.

FIG. 13 is a graphical representation of cell voltage versus time obtained in the course of Example 5.

FIG. 14 is a graphical representation of cell voltage versus time obtained in the course of Example 6.

FIG. 15 is a graphical representation of the voltage versus time profile of the 10^{th} charge segment obtained in the course of Example 6.

FIG. 16 is a graphical representation of the voltage versus time profile of the 10^{th} resting segment obtained in the course of Example 6.

FIG. 17 is a graphical representation of cell voltage versus capacity obtained in the course of Example 6. The discharge time is 7.5 days.

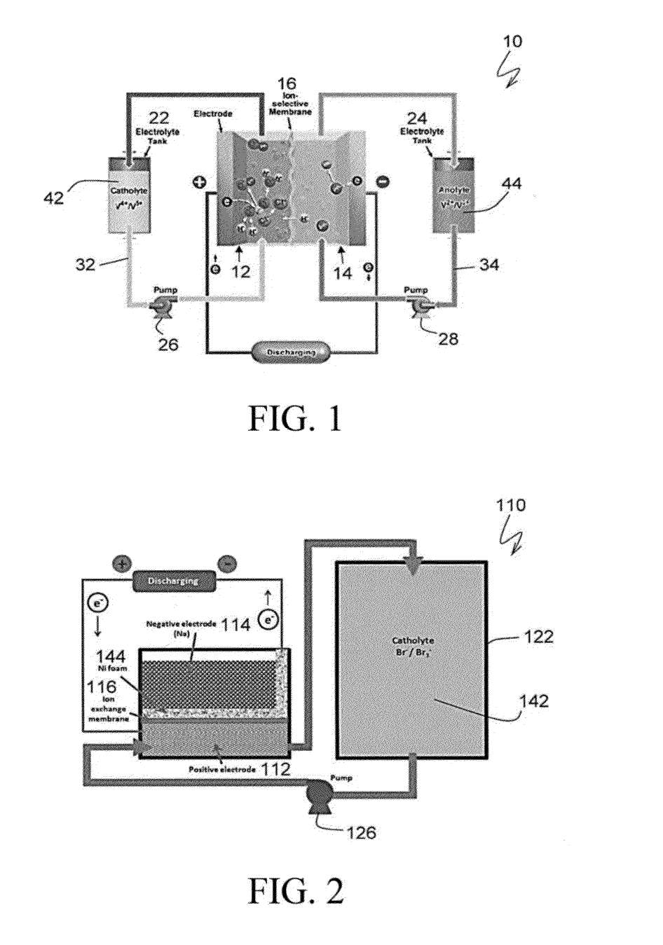

### DESCRIPTION OF THE INVENTION

As described in greater detail below, the invention generally relates to an electrochemical system used to create high voltage sodium-based hybrid flow batteries with ultrahigh energy densities. Such a system, generally designated by the reference numeral 110, in accordance with one preferred embodiment is shown in FIG. 2 and typically comprises a flow aqueous cathode 112, a non-flow sodium-based anode 114, a solid non-porous ion exchange membrane 116, a positive electrolyte tank 122 containing a respective catholyte material 142, and various accessories such as a catholyte pump 126, valves, insulators, current collectors, etc.

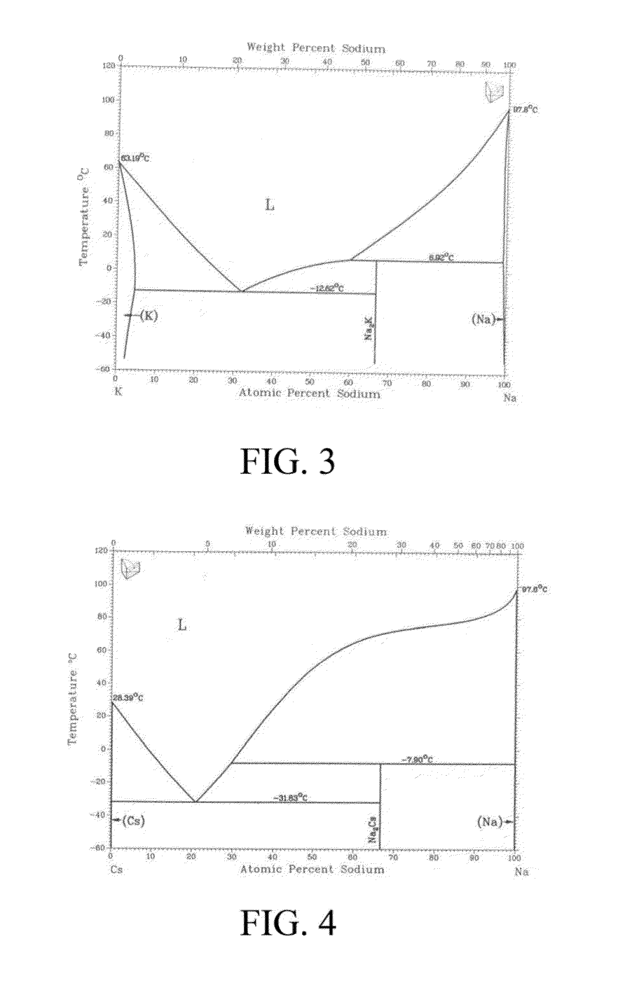

In accordance with particular embodiments, the non-flow sodium-based anode 114 can desirably be in the form of a stationary liquid sodium-based anode or a solid sodium-based anode floating on top of a liquid electrolyte, for example. Suitable liquid sodium-based anodes can desirably be composed of a molten sodium (Na), a molten sodium-potassium (Na—K) alloy, a molten sodium-cesium (Na—Cs) alloy, a molten sodium-rubidium (Na—Rb) alloy, or modified molten sodium-based alloys (such as Na—K—Rb and Na—K—Cs alloys), for example. To operate the flow battery with a molten Na anode, the battery temperature has to be higher than the melting point of Na (97.72° C.). However, using a molten Na—K alloy anode, the battery can be operated at temperatures as low as −12.6° C. (FIG. 3). If a molten Na—Cs alloy is used, the battery can be operated at a temperature as low as −31.8° C. (FIG. 4). Further, if a Na—K—Rb alloy anode is used, the operation temperature of the battery can be lower than −12.6° C. because the melting point of a Na—K—Rb is below −12.6° C., making these flow batteries operational almost anywhere, during any season and anytime around the world. In the case of a floating solid Na or Na-alloy anode, the operation temperature can be any number provided the liquid electrolyte that keeps a solid Na or Na-alloy anode float remains liquid.

The cathode comprises, contains or includes a current collector (e.g., carbon felt) through which the catholyte material 142, e.g., an aqueous or a non-aqueous solution of the positive electrolyte, is pumped or otherwise is appropriately flowed in contact. Examples of catholyte material 142 useable in the practice of the invention include: (i) aqueous sodium bromide/sodium tribromide couple, NaBr/NaBr₃, (ii) aqueous sodium ferrocyanide/sodium ferricyanide couple, Na₄[Fe(CN)₆]/Na₃[Fe(CN)₆], (iii) many other redox couples such as known in art, in aqueous and non-aqueous solutions, and (iv) combination of several redox systems into one catholyte to provide unprecedented energy densities. The half-cell and full reactions for positive electrolytes (i) and (ii) along with a molten Na anode can be written as follows.

### For the Sodium/Sodium Tribromide System:

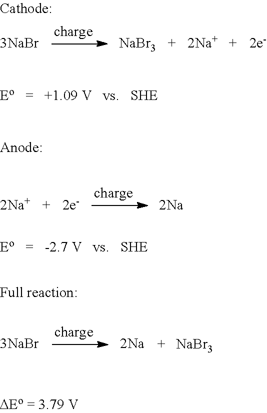

### For the Sodium/Sodium Ferricyanide System:

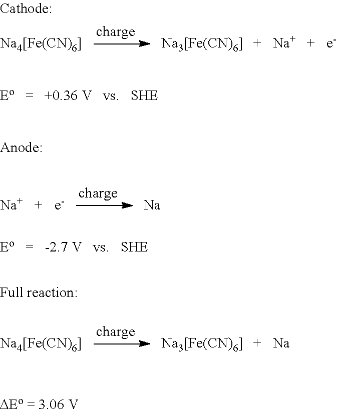

During the charge cycle of the sodium/sodium tribromide system, the bromide ions are oxidized to bromine and complexed as sodium tribromide, while the released Na⁺ ions transport across the ion exchange membrane and are converted to Na at the anode. Upon discharge, the electrochemical reactions are reversed. The open circuit cell potential for this system is around 3.79 V and varies with the concentration of the electrochemically active species. Assuming that the positive electrolyte is composed of a 6M NaBr aqueous solution, one can obtain a theoretical energy density of 369.8 Wh/L and a specific energy of 285.2 Wh/kg. In sharp contrast, the energy density and specific energy of the state-of-the-art redox flow batteries are only 20-33 Wh/L and 15-25 Wh/kg, respectively. That is, the energy density and specific energy of the sodium/sodium tribromide flow batteries are more than 10 times those of the state-of-the-art redox flow batteries (RFBs).

During the charge cycle of the sodium/sodium ferricyanide system, ferrocyanide ions are oxidized to ferricyanide ions at the positive electrode, while Na⁺ ions are reduced to Na at the negative electrode. The charge balance is accomplished by the transport of Na ions across the ion exchange membrane. Upon discharge, the electrochemical reactions are reversed. The open circuit cell potential for this system is around 3.06 V and varies with the concentration of the electrochemically active species. Assuming that the cell operates at a temperature of 98° C. and the positive electrolyte is composed of a 1.3M Na₄[Fe(CN)₆] aqueous solution, one can obtain a theoretical energy density of 106 Wh/L and a specific energy of 94 Wh/kg. These energy densities are lower than those offered by the sodium/sodium tribromide system. However, they are still much higher than those (20-33 Wh/L and 15-25 Wh/kg) derived from the state-of-the-art RFBs.

An example of the positive electrolyte (iv) is the combination of vanadium and chromium redox systems into one catholyte with the following redox reactions.

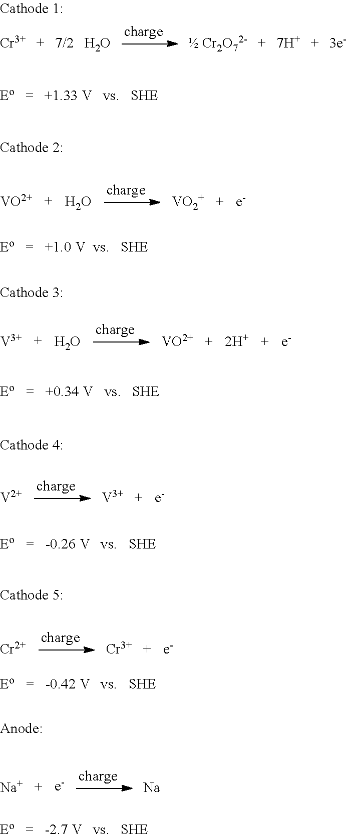

Note that such a combination of multiple cathode redox reactions is possible because the Na anode has a very low electrode potential (−2.7 V) and all the cathode redox reactions have much higher electrode potentials (>−0.42 V). Taking a reasonable solubility of V²⁺ species as 2.5 M and Cr²⁺ species as 3.0 M in aqueous solutions, one can calculate the specific energy for each redox reaction listed above. Thus, Cathode 1 reaction coupled with the anode reaction gives 696.9 Wh/kg, while Cathode 2 reaction offers 195.0 Wh/kg, Cathode 3 reaction is 160.0 Wh/kg, Cathode 4 reaction is 128.5 Wh/kg, and Cathode 5 reaction is 131.4 Wh/kg. The sum of all of the cathode reactions along with the anode reaction provides an unprecedented specific energy of 1,311.8 Wh/kg, a value that is far greater than the specific energy of current state-of-the-art Li-ion batteries. Similarly, one can combine sodium bromide (NaBr) and vanadium (V²⁺) systems into one catholyte. Assuming that the concentration of NaBr is 6 M (note: the solubility of NaBr in water is 8 M) and that of V²⁺ is 2.5 M in an aqueous solution, one will realize an unprecedented theoretic specific energy of greater higher than 760 Wh/kg.

Using non-aqueous electrolytes for the cathode can further increase the cell voltage and allow the catholyte to flow at temperatures below 0° C. Examples of non-aqueous electrolytes can include M(acac)₃ (where M=V, Cr, Mn, etc; acac is acetylacetonate), anthraquinone, 2,2-bipyridine complexes, and bis(acetylacetone)ethylenediamine cobalt electrolyte, for example. The high cell voltage resulting from the use of non-aqueous electrolytes can increase the energy density of the flow battery. However, the solubility of the active materials in non-aqueous electrolytes is typically lower than that of the active materials in aqueous electrolytes, which decreases the energy density of the flow battery. Therefore, new chemistry is required, and is currently an active area of research.

The ion exchange membrane 116 can be made of β″-Al₂O₃, NaSICON solids, or a combination thereof. For example, the membrane can consist of two layers such as with one in contact with the molten sodium and the other in contact with the aqueous electrolyte. The layer in contact with the molten Na can be an ionic liquid and the layer in contact with the aqueous electrolyte can be β″-Al₂O₃ or NaSICON. If the anode is operated with molten Na—K or Na—Cs alloys and thus allowing the cell to run at ambient temperature, organic electrolytes can be used to replace ionic liquids. The presence of an ionic liquid or organic electrolyte can increase the wettability of the molten Na, Na—Cs, Na—K, and other Na-based alloys with β″-Al₂O₃ and NaSICON ion exchange membranes, and can also allow the use of solid Na and Na alloys that can float on top of the ionic liquid or organic electrolyte.

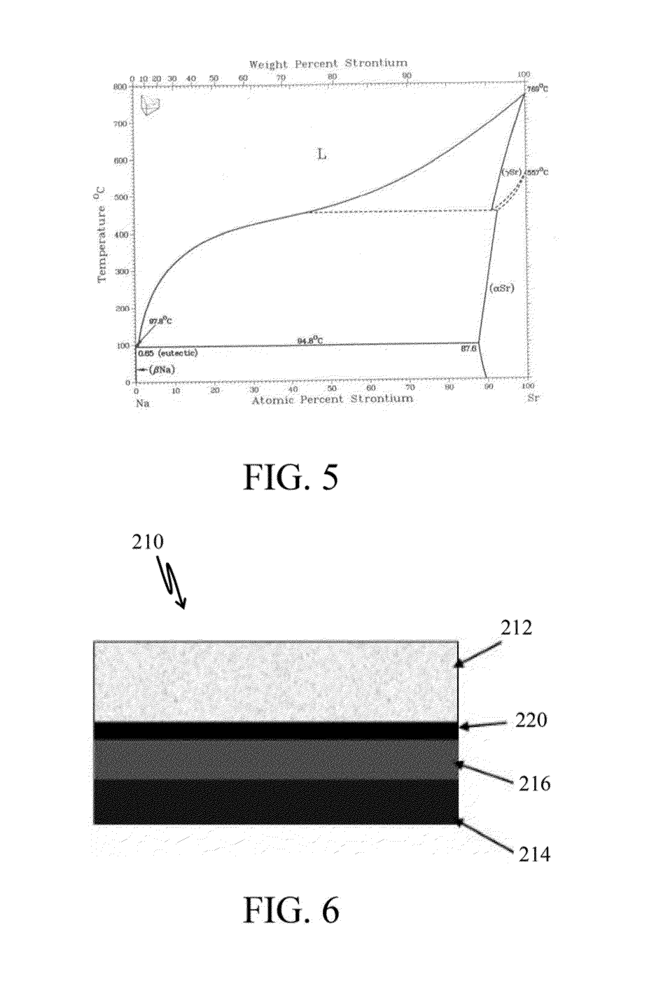

K ions can diffuse into β″-Al₂O₃ and NaSICON membranes, leading to cracking of β″-Al₂O₃ or NaSICON membranes over time. This problem can be solved via one or more of at least three below-described approaches:
1. A strontium (Sr) film of ˜20 nm can be sputter coated on the surface of β″-Al₂O₃ or NaSICON membrane(s). Na is soluble in Sr (FIG. 5) and thus can diffuse through the Sr film. In contrast, K⁺ is insoluble in Sr and thus cannot pass through the Sr film and enter the β″-Al₂O₃ or NaSICON membrane(s), thereby reducing or eliminating the cracking problem.
   FIG. 6 presents a schematic of an Sr-coated β″-Al₂O₃/NaSICON bi-layer membrane, generally designated by the numeral 210, in conjunction with a non-flow sodium-based anode 212. The Sr-coated β″-Al₂O₃/NaSICON bi-layer membrane 210 includes a layer of NaSICON 214 and a layer of β″-Al₂O₃ 216 with a Sr coating 220. In the Sr-coated bi-layer membrane 210, the Sr coating 220 acts or serves to prevent K diffusion into the bi-layer membrane, while the β″-Al₂O₃ layer 216 is Na resistant (i.e., improving the life of NaSICON) and the NaSICON layer 214 is water resistant (i.e., improving the life of β″-Al₂O₃). The Na anode 212 can sit on top of the Sr coating or float on top of a liquid electrolyte.
2. Na—Cs alloys can be used to reduce or eliminate the cracking problem. Cs⁺ ions are much larger than Na⁺ ions, and thus size selectivity prevents Cs⁺ from diffusing through β″-Al₂O₃ or NaSICON membranes, thereby avoiding the cracking problem.
3. Pure Na anodes can be used. This approach, however, requires that the operation temperature be higher than the melting temperature of Na (e.g., 98° C.) or the use of the solid Na or Na-alloy anode floating on top of a liquid electrolyte.

The orientation of the ion exchange membrane can be horizontal or vertical. However, a horizontal orientation (such as shown in FIG. 2) offers several distinct advantages. First, with the horizontal orientation the wettability of the molten Na and its alloys on the surface of the membrane is not critical in determining the utilization of the membrane area and thus the power of the flow battery. In this orientation, the entire area of the membrane is fully utilized for Na ion transport regardless of the amount of the molten Na and its alloys in the anodic chamber. However, if a vertical orientation is used, the area of the membrane that can be utilized depends on the amount of the molten Na and its alloys and their wettability on the surface of the membrane. Under such conditions, the power of the battery will typically vary with the amount of the molten Na and its alloys in the anodic chamber during charge/discharge. Second, a vertical orientation can make the use of two-layer membranes, (e.g., one a solid layer and the other a liquid layer) such as discussed above, extremely difficult if not impossible. Third, the use of vertical orientation increases the risk that thin and brittle β″-Al₂O₃ and NaSICON membranes may break. This risk is present particularly when the battery is in the fully discharged state under which the anodic chamber is almost empty and the thin membrane has to resist the liquid pressure from the cathodic chamber. Such a risk can be averted by adding nickel (Ni) foam 144 such as in the form of a layer disposed onto the molten Na side to strengthen the membrane 116, but with the increased material cost and complication of battery assembling associated therewith.

The thickness of the solid non-porous membrane 116 preferably should be made as thin as possible (e.g., 1 mm or less). To provide mechanical support to such a thin solid membrane, an appropriate support element such as a porous foam can be added, if needed or desired. This can be done by adding a nickel (Ni) foam to the molten Na side, such as described above and/or adding an aluminum (Al) foam or graphite fiber foam to the cathode side, depending on the specific conditions of operation and the cell chemistry.

As will be appreciated by those skilled in the art and guided by the teachings herein provided, in accordance with one preferred embodiment of the invention, the aqueous anode electrolyte of a conventional RFB is replaced by a molten or solid Na, Na—Cs, Na—K, or Na-based ternary, quaternary and quinary alloys, leading to an increase in the cell voltage to around 3 or 4 volts, depending on the cathode chemistry. The use of a molten or solid Na and Na-based alloys also increases the energy density directly because the energy densities of Na, Na—K, Na—Cs and other Na-based alloys are higher than those provided by the aqueous electrolytes. This is the case because the concentration of the active species in the aqueous solution is limited by their solubility in water.

Another advantage of the Na-based flow batteries is the use of β″-Al₂O₃ and NaSICON membranes to replace Nafion membranes in the state-of-the-art RFBs. The use of Nafion membranes suffers from several shortcoming or problems such as high cost and low ion selectivity. The latter can result in ion cross transport, leading to quick performance degradation. By replacing the aqueous anode electrolyte with a molten Na, Na—Cs, Na—K, or other Na-based alloys, no pump is needed for the anode as the molten Na, Na—Cs, Na—K, or other Na-based alloys are always in contact with the membrane regardless of the amount of Na, Na—Cs, Na—K, or other Na-based alloys. This situation remains true even for solid Na and Na-alloy anodes because they float on top of a liquid electrolyte which keeps them in contact with the membrane regardless of the amount of the solid Na and Na alloys. An additional advantage to using a stationary or floating Na-based anode is avoidance of the need for pumping in the anode, which increases system energy efficiency.

This novel technology can have high impact on stationary energy storage. By having a flow system capacity and power coupled with Li-ion battery-like energy densities, the Na-based flow batteries such as herein described can significantly reduce the demand for the amount of storage materials and space needed and decrease the cost accordingly. These features make the high voltage, high capacity Na-based flow batteries suitable not only for electrical energy storage at remote locations where space is not a concern, but also for electrical energy storage in populated areas where space is typically at a premium. Therefore, Na-based hybrid flow batteries such as herein described have the flexibility for all levels of electric energy storage, including electricity generation site storage, electricity transmission-substation storage, community storage, and end user storage. Further, Na-based hybrid flow batteries such as herein described can play a critical role in renewable energy integration and enable the future grid that integrates a significant level of renewable energy and provides high quality power to customers and the electrified transportation.

High voltage, high capacity Na-based hybrid flow batteries such as herein described can also make possible the widespread market penetration of electric vehicles. With a flow system capacity and power coupled with Li-ion battery-like energy densities, Na-based hybrid flow batteries such as herein described can solve the driving distance and charging time problems faced by Li-ion batteries. Currently, Fiat's 500e, an all-electric vehicle just rolled out in November 2012, is powered by Li-ion batteries with a driving range of 80 miles and requires about 4 hours of recharge time with a 240-volt charging station. Clearly, there is ample room for improvement in both driving distance and recharge time. To date, the most advanced recharging technology is represented by the Model S electric car produced by Tesla Motors. It takes half an hour to recharge for a driving distance of 150 miles using the best technology available today (Tesla's Supercharger stations installed in September 2012). In sharp contrast, it is possible to recharge a Na-based hybrid flow battery powered vehicles with a 300-mile driving distance in several minutes. This can be done much like pumping gasoline into an internal combustion engine vehicle. Specifically, recharging can be achieved by pumping the used positive electrolyte from the car to the refueling station and pumping the molten Na—K alloy and the charged positive electrolyte from the refueling station into the anodic chamber and the positive electrolyte tank, respectively. The used positive electrolyte can then be recharged in the refueling station to form the molten Na—K alloy and the charged positive electrolyte, ready for recharging of other electrical vehicles.

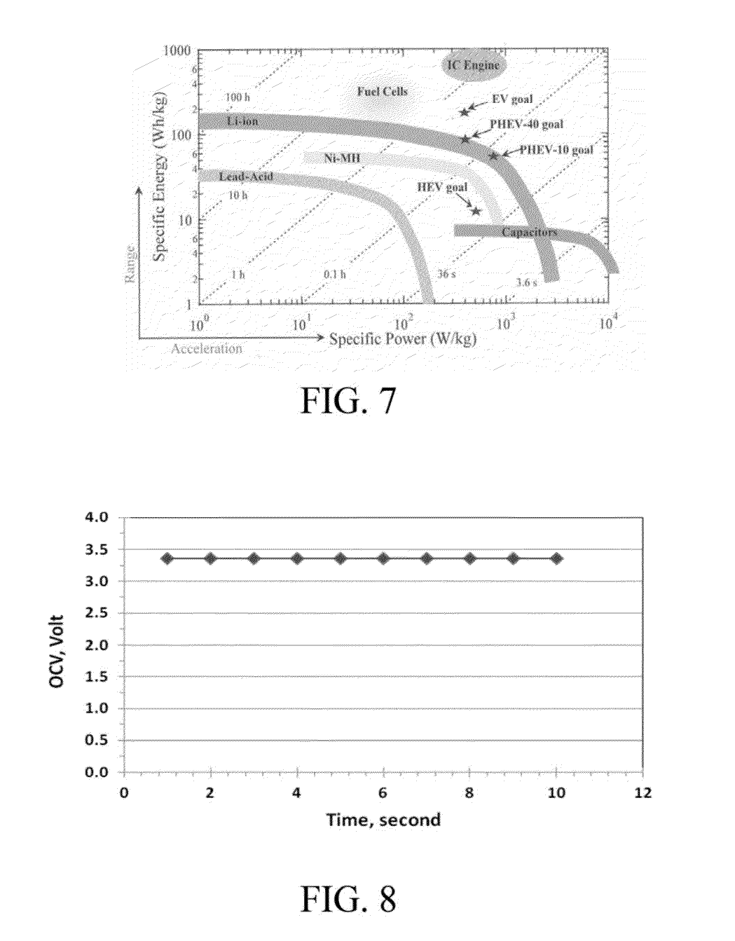

The invention desirably solves the critical problems or shortcomings of low energy density and low specific energy typically associated with current state-of-the-art RFBs by offering energy densities (e.g., 369.8 Wh/L and 285.2 Wh/kg) that can compete with the best Li-ion batteries known today. FIG. 7 compares the relative performance of various electrochemical energy storage devices available today. As can be seen, the specific energy of Li-ion batteries ranges from 120 to 210 Wh/kg while suffering low specific power (W/kg) and low storage capacity (kWh). Therefore, the high voltage Na-based hybrid flow batteries disclosed in this invention have Li-ion battery-like energy densities while possessing high specific powers and storage capacities. Such novel flow batteries combining all the desired features in one system can serve to revolutionize the field of the energy storage technology and change life around us.

The present invention is described in further detail in connection with the following examples which illustrate or simulate various aspects involved in the practice of the invention. It is to be understood that all changes that come within the spirit of the invention are desired to be protected and thus the invention is not to be construed as limited by these examples.

### EXAMPLES

The following Experimental Data was obtained for the subject Sodium-Based Hybrid Flow Batteries:

### Example 1

### Open Circuit Voltage (OCV) for the Following Anode/Cathode System

### Experimental Conditions

Anode: Na-44 wt % K
Cathode: 1M Fe(NO₃)₃ solution with a small amount of sodium dodecyl sulfate (SDS) surfactant
Ion exchange membrane: β″-Al₂O₃ disc
Temperature: 25° C.
Device used to measure the electrochemical properties: a VersSTAT4 potentiostat/galvanostat (made by Princeton Applied Research)

The half-cell and full reactions for this system can be written approximately as follows:

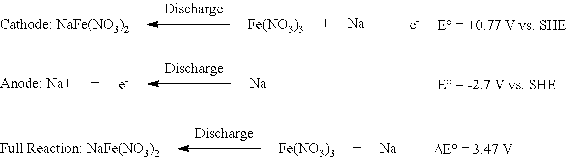

The measured OCV was 3.36 V (see FIG. 8), i.e., 0.1 V lower than the theoretical value.

### Example 2

### Current Measured from Cyclic Voltammetry Using a Two-Electrode Setup

### Experimental Conditions

Anode: Na-80 wt % K
Cathode: 6M NaBr solution
Ion exchange membrane: β″-Al₂O₃ disc
Temperature: 25° C.
Device used to measure the electrochemical properties: a VersSTAT4 potentiostat/galvanostat (made by Princeton Applied Research)

The half-cell and full reactions for sodium/sodium tribromide system can be written approximately as follows:

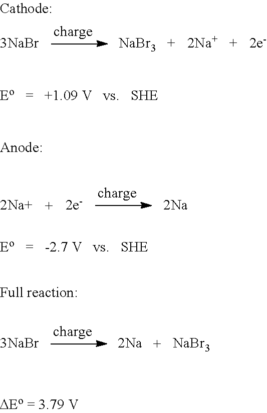

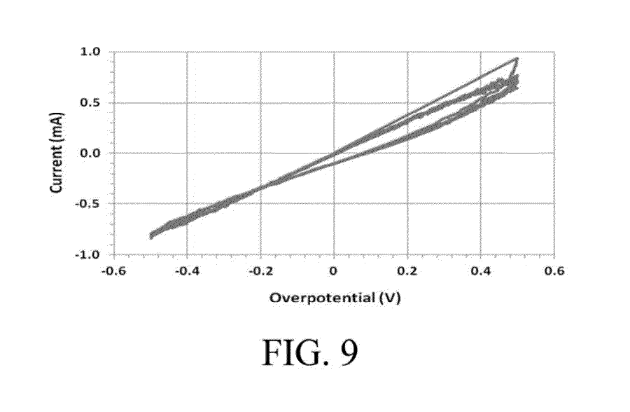

The current was measured at the cathode during cyclic voltammetry using a two-electrode setup (i.e., the working electrode: NaBr, and the counter electrode: Na-80% K). As shown in FIG. 9, the current was a function of the overpotential. The measured current, however, was low. The largest current measured was only 0.8 mA. This was not unexpected as the cathode at the electrode side was not optimized.

### Example 3

### Charge/Discharge of a Floating Solid Na Anode Versus a Manganese Acetylacetonate Catholyte without Stirring

### Experimental Conditions

Anode: a solid Na chuck floating on top of an ionic liquid (IL), methyl-butyl-pyrrolidinium bis(trifluoromethylsulfonyl) imide, with 0.1M sodium trifluoromethylsulfonyl imide (NaTFSI) salt
Cathode: 0.05M manganese acetylacetonate (Mn(acac)₃) dissolved in acetonitrile (CH₃CN) with a tinned copper current collector
Ion exchange membrane: β″-Al₂O₃ disc
Temperature: 25° C.
Device used to measure the electrochemical properties: a VersSTAT4 potentiostat/galvanostat (made by Princeton Applied Research)
   The expected electrochemical reaction at the anode was:

Na [symbol] Na⁺+e⁻E⁰=−2.7 V vs. SHE (1)

Several possible electrochemical reactions could take place at the catholyte:

Mn⁴⁺+e⁻ [symbol] Mn³⁺ E⁰=1.5 V vs. SHE (2)

Mn³⁺+e⁻ [symbol] Mn²⁺ E⁰=0.4 V vs. SHE (3)

Mn²⁺+2e⁻ [symbol] Mn⁰ E⁰=−1.18 V vs. SHE (4)

If all of the reactions above are completed, four (4)-electron transfer redox reactions can be provided by one Mn ion, leading to a very high energy density. However, reaction (4) is not desirable because it could result in precipitation and thus irreversibility. Nevertheless, reactions (2) and (3) can be utilized, offering 2-electron transfer redox reactions at the catholyte. The pair between reactions (1) and (2) will result in a theoretical open circuit voltage (OCV) at 4.2 V, while the pair between reactions (1) and (3) will have a theoretical OCV at 3.1 V.

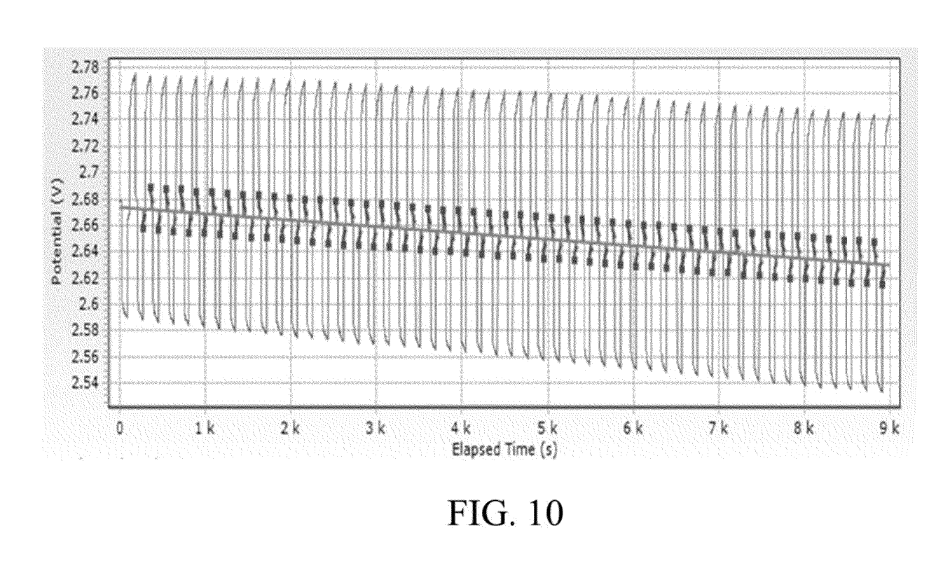

FIG. 10 shows the charge/discharge curve of the aforementioned setup under the conditions: current=0.05 mA, 60 seconds for each charge and discharge segment, 50 cycles, and no stirring at the catholyte. It can be seen that the open circuit voltage (OCV) was 2.67 V at the beginning of the cycle, suggesting that the electrochemical reactions for charge/discharge are due to the pair between reactions (1) and (3). A gradual decrease in the OCV was also obvious. The reason for this phenomenon is likely related to the mass diffusion issue, i.e., the diffusion distance becomes longer as the Mn³⁺ species get consumed. As the concentration of the Mn ions near the working electrode changes with cycles, the redox potential varies as well. The following example proves that this is indeed the case.

### Example 4

### Charge/Discharge of a Floating Solid Na Anode Versus a Manganese Acetylacetonate Catholyte with Stirring

### Experimental Conditions

Anode: Same as Example 3
Cathode: Same as Example 3
Ion exchange membrane: β″-Al₂O₃ disc
Temperature: 25° C.
Device used to measure the electrochemical properties: Same as Example 3

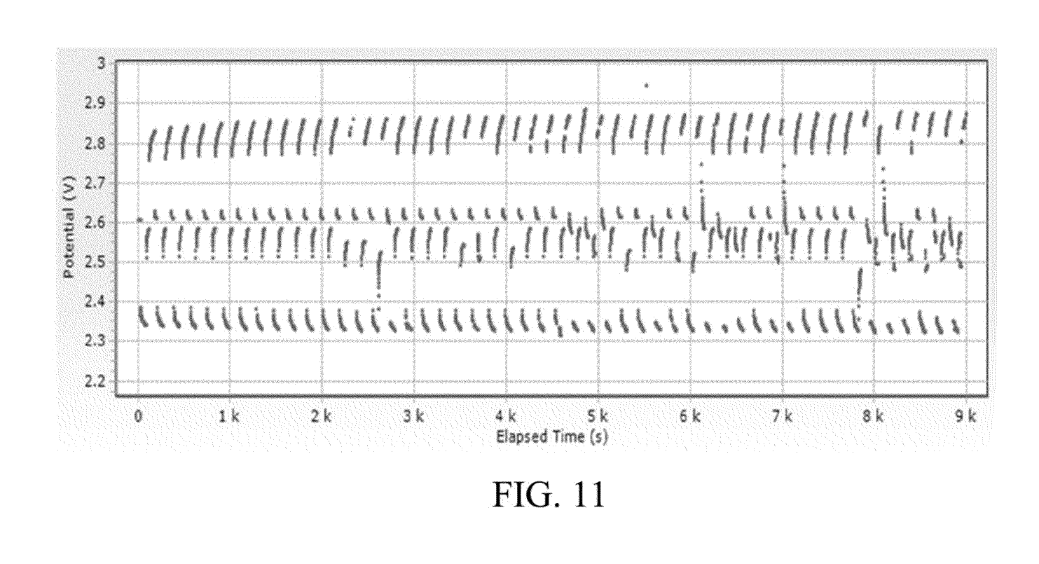

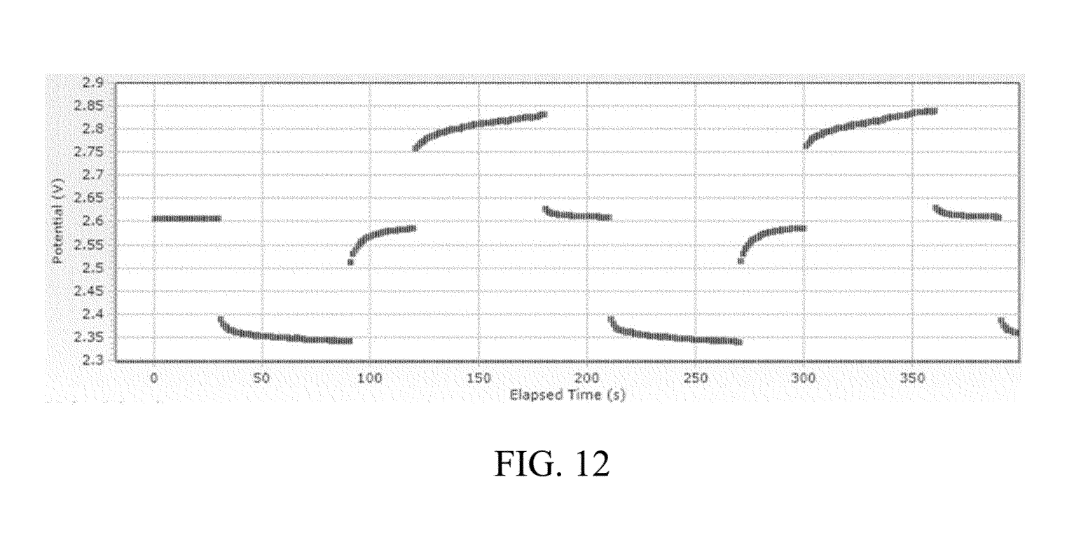

This example was conducted at the same conditions as Example 3 except the following. (i) The Mn(acac)₃ catholyte was stirred continuously to minimize the diffusion gradient on the surface of the tinned copper current collector; (ii) Insertion of a 30-second resting time between charge and discharge (60 seconds each) segments; and (iii) current=0.1 mA. FIG. 11 shows the charge/discharge curve of Example 4. The four bands of data in. FIG. 11 from the top correspond to the voltage during charging (60 s per charging segment), OCV after charging (resting for 30 s), OCV after discharging (resting for 30 s), and the voltage while discharging (60 s per discharging segment). Note that the OCV now is steady at 2.6 V over 50 cycles with stirring of the catholyte. However, the voltages in all segments (charging, discharging, and open circuit resting) change gradually. FIG. 12 provides a close look at how these voltages change gradually in the first two cycles of FIG. 11. It is clear that the voltages upon charging and discharging as well as the OCV during resting did not display a plateau. Instead, the voltage changed in all segments. The voltage change during charging and discharging can be attributed to the composition change of the catholyte and the voltage change during open circuit resting to the composition gradients near the current collector (the working electrode) in the catholyte. As discharging (and charging) takes place, the average composition of the catholyte changes and so does the redox potential. Regardless of stirring or no stirring, a diffusion layer is expected to be present near the tinned copper current collector where electrochemical reactions take place. Therefore, upon resting the composition gradient becomes smaller as diffusion takes place during resting. Note that the OCV after discharging increased gradually, while the OCV after charging decreased gradually, with both converging to 2.6 V. These phenomena are consistent with the expectations of the gradually diminished composition gradient and the recovery of the nominal composition of the catholyte at the working electrode surface as resting prolongs.

The voltage change observed in this study is comparable or smaller than that reported in the literature for acetylacetonate catholytes. The reported voltage change during discharging ranged from 0.2 V to 0.5 V, while the observed voltage change for Example 4 was from 0.1 to 0.2 V, suggesting that stirring is very effective in minimizing the composition gradient in the catholyte. In addition, it is noted that the overpotentials observed for charge and discharge polarization were ˜0.2 V, which are small considering that no electrode optimization has been implemented in this experiment.

### Example 5

### Charge/Discharge of a Floating Solid Na Anode Versus a Manganese Acetylacetonate Catholyte with Stirring and a Stainless Steel Wire Pressed into a Carbon Foam Used as the Current Collector

### Experimental Conditions

Anode: Same as Example 4
Cathode: 0.05M Mn(acac)₃ and 0.05M NaClO₄ dissolved in acetonitrile (CH₃CN) with a stainless steel wire current collector
Ion exchange membrane: β″-Al₂O₃ disc
Temperature: 25° C.
Device used to measure the electrochemical properties: Same as Example 4

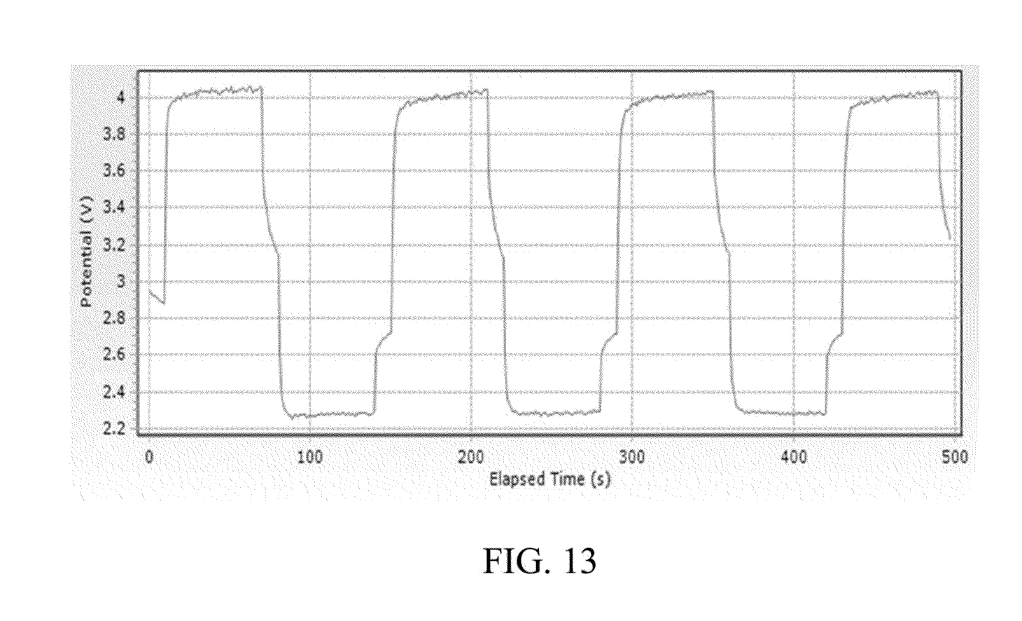

This example was identical to Example 4 except the following two points:
(i) A stainless steel wire pressed into a carbon foam was used as the current collector to replace the tinned copper wire, and
(ii) 0.05M NaClO₄ was added to the catholyte as the supporting electrolyte.
   For Examples 3 and 4, it is noted that the measured OCV was around 2.6 V which is lower than the theoretical voltage (3.1 V). The lower OCV is attributed to corrosion of the tinned copper wire because some degree of corrosion was noticed. Therefore, in this experiment a stainless steel wire pressed into a carbon foam was used to replace the tinned copper wire. The use of stainless steel wire pressed into a carbon foam resulted in an increase of the OCV to 3 V, as shown in FIG. 13. Therefore, with proper selection of the current collector and stirring of the catholyte, Mn(acac)₃ dissolved in acetonitrile with or without the NaClO₄ supporting electrolyte can serve as an effective catholyte.

### Example 6

### Charge/Discharge of a Floating Solid Na Anode Versus a Manganese Acetylacetonate Catholyte with Stirring and a Pt Wire as the Current Collector

### Experimental Conditions

Anode: Same as Example 5
Cathode: 0.025M Mn(acac)₃ and 0.1M NaClO₄ dissolved in acetonitrile (CH₃CN) with a Pt wire pressed into a carbon foam used as the current collector
Ion exchange membrane: α″-Al₂O₃ disc
Temperature: 25° C.
Device used to measure the electrochemical properties: Same as Example 5

In Examples 3-5 the OCV was near or lower than 3.1 V, indicating that the redox reaction at the cathode responsible for charge/discharge was reaction (3), i.e., is due to the Mn²⁺/Mn³⁺ redox couple. This is not surprising because the chemical used in Examples 3-5 was Mn(acac)₃ which contains Mn³⁺ species at the beginning of the test. To increase the energy density of a flow battery, both Mn²⁺/Mn³⁺ and Mn³⁺/Mn⁴⁺ redox couples need to be utilized. This can be done with sodium-based hybrid flow batteries. Ideally, a chemical containing Mn⁴⁺ species should be used for this purpose. However, no such chemicals are available. Thus, Mn⁴⁺ species was created via an electrochemical method by charging the mixture of 0.025M Mn(acac)₃ and 0.1M NaClO₄ versus a Na anode with the following reaction.

Mn(acac)₃+NaClO₄═Mn(acac)₃(ClO₄)+Na⁺+e⁻

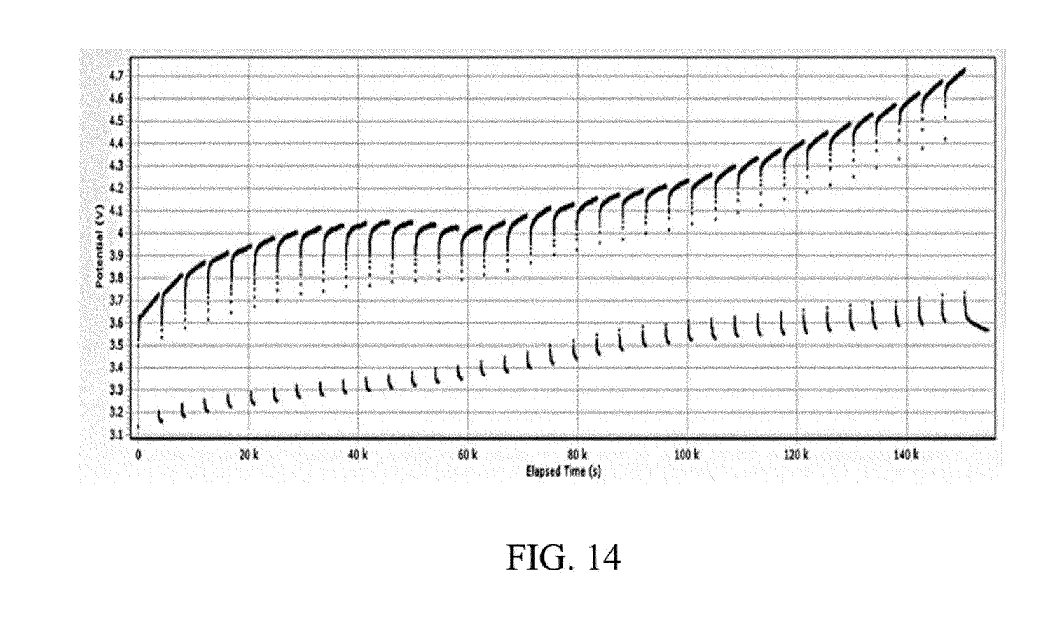

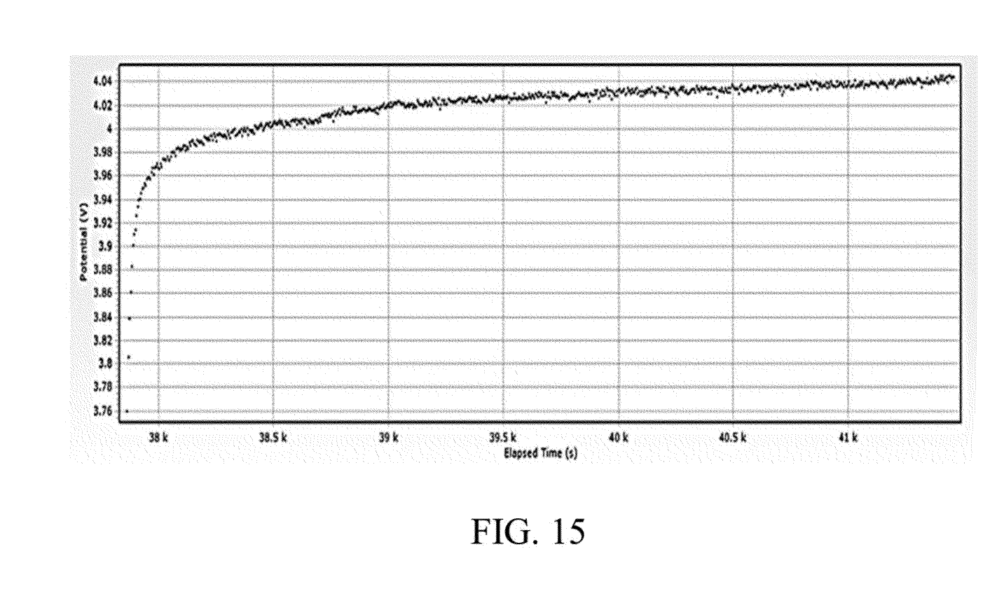

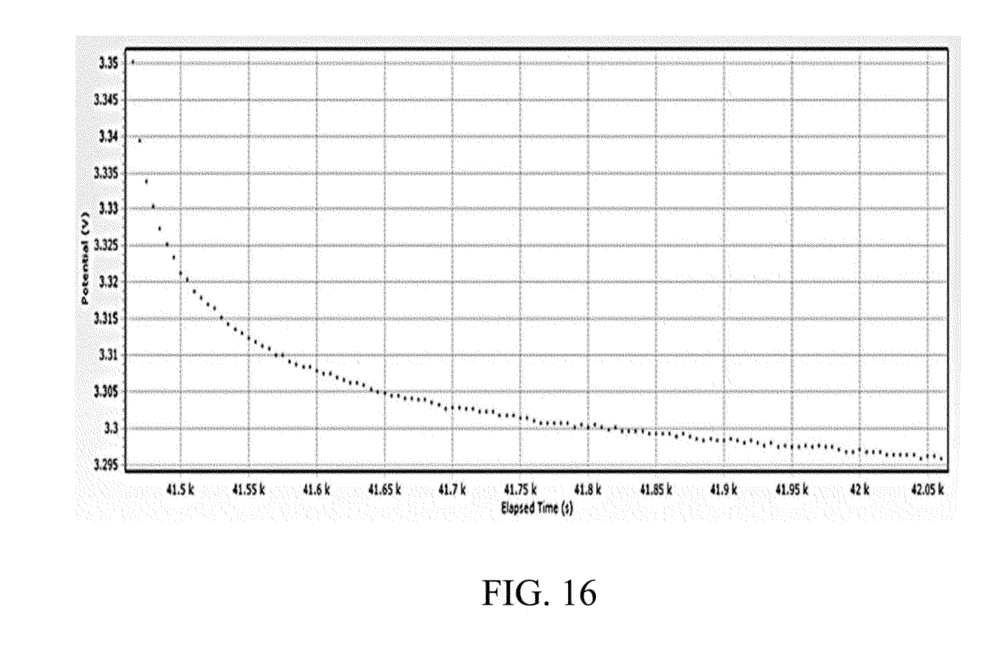

In this redox reaction, Na⁺ ions diffuse through the β″-Al₂O₃ membrane and deposit at the anode as Na, while Mn³⁺ ions at the catholyte are oxidized to become Mn⁴⁺. FIG. 14 shows the charge curve of Example 6. Note that the initial voltage was 3.1 V because of the use of Mn(acac)₃ as the starting chemical. The cell was charged for 36 h at a constant current of 0.25 mA with 1 h per charge segment and 10-min resting time between the adjacent charge segments. Note that the voltage increased gradually during each charge segment and decreased during each resting segment. FIGS. 15 and 16 provide a close look at the voltage change during a charge and resting segment, respectively. The gradual increase in the voltage during charge (FIG. 15) is attributed to the conversion of Mn³⁺ to Mn⁴⁺ and the gradual increase in the Me concentration. The gradual decrease in the voltage during resting (FIG. 16) is related to the gradually decreased composition gradient at the working electrode surface as diffusion takes place during resting. After charging for 36 h and followed by 43-h resting, the final OCV became 3.5 V. This value is higher than 3.1 V (corresponding to Mn²⁺/Mn³⁺ couple), but lower than 4.2 V (corresponding to Mn³⁺/Mn⁴⁺ couple). Therefore, the catholyte after charge contained a mixture of Mn³⁺ and Mn⁴⁺ ions.

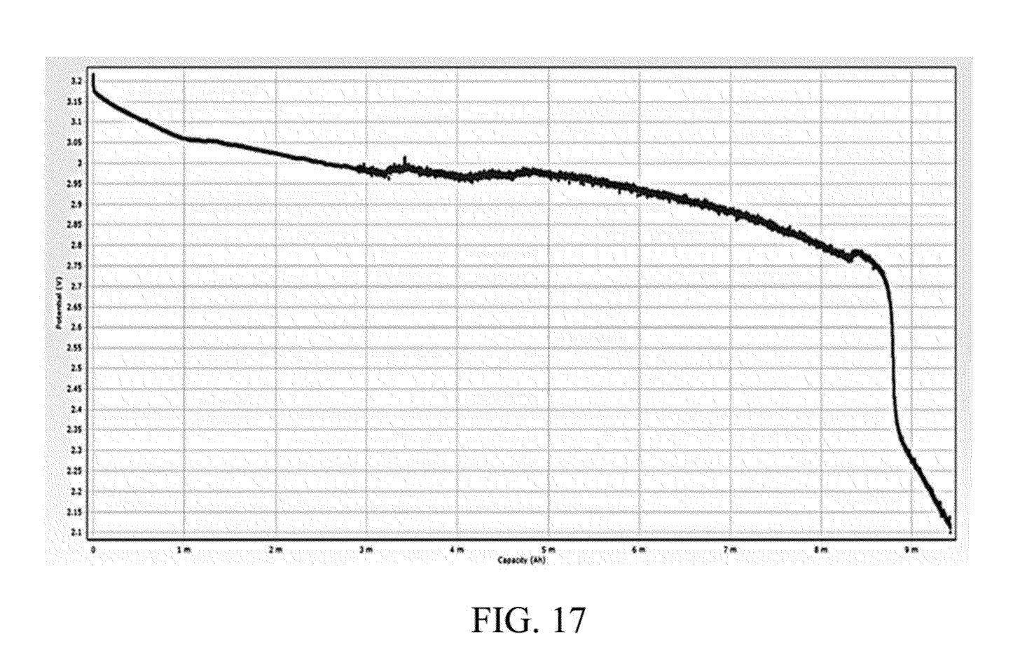

FIG. 17 presents the discharge curve of Example 6 after the catholyte has been charged for 36 h at a current of 0.25 mA. The discharge current was set at 0.05 mA. Note that the cell voltage decreased gradually during discharge. This is consistent with the gradual decrease in the Mn⁴⁺ concentration as Mn⁴⁺ ions are reduced to Mn³⁺ and then Mn³⁺ ions are reduced to Mn²⁺. Based on the previous examples (see Examples 3 to 5), it is known that the overpotentials for charge and discharge polarization are about 0.2 V. Taking a very conservative approach assuming that the overpotential for discharge polarization is 0.1 V (rather than 0.2 V), then the discharge in the cell voltage from 3.2 V to 3.0 V is derived from reduction of Mn⁴⁺ to Mn³⁺ and the discharge in the cell voltage from 3.0 V to below 3.0 V is due to reduction of Mn³⁺ to Mn²⁺. Thus, it can be concluded that 30% discharge capacity is due to the Mn⁴⁺/Mn³⁺ redox reaction and 70% discharge capacity comes from the Mn³⁺/Mn²⁺ redox reaction. If the overpotential for discharge polarization is assumed to be 0.05 V, then the Mn⁴⁺/Mn³⁺ redox reaction accounts for 15% discharge capacity. If the overpotential for discharge polarization is assumed to be 0.15 V, then the Mn⁴⁺/Mn³⁺ redox reaction accounts for most of the discharge capacity (i.e., 60%). In any case, this example clearly demonstrates that multiple electron transfer redox reactions per Mn ion can be achieved via the sodium-based hybrid flow batteries. No such flow batteries are commercially available to date.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A sodium-based hybrid flow battery, the battery comprising:
a flow cathode, said flow cathode in fluid flow communication with a source of a catholyte material,
a non-flow sodium-based anode spaced apart from said flow cathode, and
a solid non-porous ion exchange membrane disposed between said flow cathode and said anode,
wherein flow of the catholyte material in said flow cathode and diffusion of sodium ions through said non-porous ion exchange membrane produce electrical energy.

2. The sodium-based hybrid flow battery of claim 1 wherein said non-flow sodium-based anode comprises a stationary liquid sodium-based anode.

3. The sodium-based hybrid flow battery of claim 2 wherein the stationary liquid sodium-based anode comprises molten sodium or a molten sodium-containing alloy.

4. The sodium-based hybrid flow battery of claim 3 wherein the stationary liquid sodium-based anode comprises a molten sodium-containing alloy and wherein the molten sodium-containing alloy also includes at least one of potassium, cesium, rubidium and combinations thereof.

5. The sodium-based hybrid flow battery of claim 1 wherein said non-flow sodium-based anode comprises a solid sodium-based anode disposed on liquid electrolyte.

6. The sodium-based hybrid flow battery of claim 5 wherein the solid sodium-based anode floats on the liquid electrolyte.

7. The sodium-based hybrid flow battery of claim 6 wherein the liquid electrolyte is an ionic liquid.

8. The sodium-based hybrid flow battery of claim 6 wherein the liquid electrolyte is an organic electrolyte.

9. The sodium-based hybrid flow battery of claim 1 wherein the catholyte material comprises an aqueous solution.

10. The sodium-based hybrid flow battery of claim 1 wherein the catholyte material comprises a non-aqueous solution.

11. The sodium-based hybrid flow battery of claim 1 wherein the catholyte material comprises ions having at least one electron transfer redox reaction per active ion.

12. The sodium-based hybrid flow battery of claim 11 wherein the catholyte material comprises at least one metallic ion selected from the group consisting of manganese, vanadium, chromium and combinations thereof.

13. The sodium-based hybrid flow battery of claim 11 wherein the ionic material comprises a compound selected from the group consisting of sodium tribromide, sodium ferricyanide, sodium cobalt perchlorate, sodium iron nitrate, and combinations thereof.

14. The sodium-based hybrid flow battery of claim 1 wherein said solid non-porous ion exchange membrane comprises a material selected from the group consisting of β″-Al₂O₃, a NaSICON solid, and combinations thereof.

15. The sodium-based hybrid flow battery of claim 14 wherein said solid non-porous ion exchange membrane comprises a first layer of β″-Al₂O₃ and an adjacent layer of a NaSICON solid.

16. The sodium-based hybrid flow battery of claim 14 additionally comprising a layer of ionic liquid disposed on said solid non-porous ion exchange membrane.

17. The sodium-based hybrid flow battery of claim 1 additionally comprising support element disposed adjacent said solid non-porous ion exchange membrane.

18. The sodium-based hybrid flow battery of claim 17 wherein said support element comprises a porous foam.

19. The sodium-based hybrid flow battery of claim 18 wherein the porous foam comprises a material selected from the group consisting of nickel, copper, stainless steel and combinations thereof and is disposed on the anode-adjacent side of said solid non-porous ion exchange membrane.

20. The sodium-based hybrid flow battery of claim 18 wherein the porous foam comprises a material selected from the group consisting of aluminum, graphite, stainless steel and combinations thereof and is disposed on the cathode-adjacent side of said solid non-porous ion exchange membrane.

21. The sodium-based hybrid flow battery of claim wherein said solid non-porous ion exchange membrane is disposed in a horizontal orientation.

22. The sodium-based hybrid flow battery of claim 1 wherein said solid non-porous ion exchange membrane is disposed in a vertical orientation.

23. A high voltage sodium-based hybrid flow battery with ultrahigh energy density, said battery comprising:
a flow cathode, said flow cathode in fluid flow communication with a source of a catholyte material,
a stationary sodium-based anode spaced apart from said flow cathode, said stationary sodium-based anode comprising molten sodium or a molten sodium-containing alloy and
a solid non-porous ion exchange membrane disposed in a horizontal orientation between said flow cathode and said anode, said solid non-porous ion exchange membrane comprising a material selected from the group consisting of β″-Al₂O₃, a NaSICON solid, and combinations thereof,
wherein flow of the catholyte material in said flow cathode and diffusion of sodium ions through said solid non-porous ion exchange membrane produces electrical energy.

24. A method of producing electrical energy via a sodium-based hybrid flow battery, the sodium-based hybrid flow battery containing a flow cathode and a non-flow sodium-based anode with a solid non-porous ion exchange membrane disposed therebetween, said method comprising:
flowing a catholyte material in the flow cathode in communication with the non-flow sodium-containing anode through the solid non-porous ion exchange membrane,
diffusing sodium ions from the non-flow sodium-based anode to the flow cathode through the solid non-porous ion exchange membrane for discharge and
diffusing sodium ions from the flow cathode to the non-flow sodium-based anode through the solid non-porous ion exchange membrane for charge.
